(19) United States
(12) Patent Application Publication
(10) Pub. No.: US 2015/0006776 A1
(43) Pub. Date: Jan. 1, 2015

(54) ON-CHIP MESH INTERCONNECT

(71) Applicants: Yen-Cheng Liu, Portland, OR (US); Jason W. Horihan, Hillsboro, OR (US); Krishnakumar Ganapathy, Portland, OR (US); Umit Y. Ogras, Hillsboro, OR (US); Allen W. Chu, Portland, OR (US); Ganapati N. Srinivasa, Portland, OR (US)

(72) Inventors: Yen-Cheng Liu, Portland, OR (US); Jason W. Horihan, Hillsboro, OR (US); Krishnakumar Ganapathy, Portland, OR (US); Umit Y. Ogras, Hillsboro, OR (US); Allen W. Chu, Portland, OR (US); Ganapati N. Srinivasa, Portland, OR (US)

(21) Appl. No.: 14/126,883

(22) PCT Filed: Jun. 29, 2013
(86) PCT No.: PCT/US2013/048800

§ 371 Date: Dec. 17, 2013

(51) Int. Cl. G06F 13/40

(52) U.S. Cl. CPC G06F 13/4031
USPC 710/113

(57) ABSTRACT

A particular message is received at a first ring stop connected to a first ring of a mesh interconnect including a plurality of rings oriented in a first direction and a plurality of rings oriented in a second direction substantially orthogonal to the first direction. The particular message is injected on a second ring of the mesh interconnect. The first ring is oriented in the first direction, the second ring is oriented in the second direction, and the particular message is to be forwarded on the second ring to another ring stop of a destination component connected to the second ring.

### FIELD

This disclosure pertains to computing systems, and in particular (but not exclusively) multi-core processor interconnect architectures.

### BACKGROUND

Processor chips have evolved significantly in recent decades. The advent of multi-core chips has enabled parallel computing and other functionality within computing devices including personal computers and servers. Processors were originally developed with only one core. Each core can be an independent central processing unit (CPU) capable of reading executing program instructions. Dual-, quad-, and even hexa-core processors have been developed for personal computing devices, while high performance server chips have been developed with upwards of ten, twenty, and more cores. Cores can be interconnected along with other on-chip components utilizing an on-chip interconnect of wire conductors or other transmission media. Scaling the number of cores on a chip can challenge chip designers seeking to facilitate high-speed interconnection of the cores. A variety of interconnect architectures have been developed including ring bus interconnect architectures, among other examples.

### BRIEF DESCRIPTION OF THE DRAWINGS

FIG. 1 illustrates an embodiment of a block diagram for a computing system including a multicore processor.

FIG. 2 illustrates a block diagram of a multi-core chip utilizing a first embodiment of a ring interconnect architecture.

FIG. 3 illustrates a block diagram of a multi-core chip utilizing a second embodiment of a ring interconnect architecture.

FIG. 4 illustrates a block diagram of a multi-core chip utilizing an example embodiment of a ring mesh interconnect architecture.

FIG. 5 illustrates a block diagram of a first example ring stop in an example ring mesh interconnect architecture.

FIG. 6 illustrates a block diagram of a second example ring stop in an example ring mesh interconnect architecture.

FIG. 7 illustrates a block diagram of tile connected to an example ring mesh interconnect.

FIG. 8 illustrates an example floor plan of a multi-core chip utilizing an example embodiment of a ring mesh interconnect architecture.

FIGS. 9A-9C illustrate example flows on an example ring-mesh interconnect.

FIGS. 10A-10B illustrate flowcharts showing example techniques performed using an example ring-mesh interconnect.

FIG. 11 illustrates another embodiment of a block diagram for a computing system.

Like reference numbers and designations in the various drawings indicate like elements.

### DETAILED DESCRIPTION

In the following description, numerous specific details are set forth, such as examples of specific types of processors and system configurations, specific hardware structures, specific architectural and micro architectural details, specific register configurations, specific instruction types, specific system components, specific measurements/heights, specific processor pipeline stages and operation etc. in order to provide a thorough understanding of the present invention. It will be apparent, however, to one skilled in the art that these specific details need not be employed to practice the present invention. In other instances, well known components or methods, such as specific and alternative processor architectures, specific logic circuits/code for described algorithms, specific firmware code, specific interconnect operation, specific logic configurations, specific manufacturing techniques and materials, specific compiler implementations, specific expression of algorithms in code, specific power down and gating techniques/logic and other specific operational details of computer system haven't been described in detail in order to avoid unnecessarily obscuring the present invention.

Although the following embodiments may be described with reference to energy conservation and energy efficiency in specific integrated circuits, such as in computing platforms or microprocessors, other embodiments are applicable to other types of integrated circuits and logic devices. Similar techniques and teachings of embodiments described herein may be applied to other types of circuits or semiconductor devices that may also benefit from better energy efficiency and energy conservation. For example, the disclosed embodiments are not limited to desktop computer systems or Ultrabooks™. And may be also used in other devices, such as handheld devices, tablets, other thin notebooks, systems on a chip (SOC) devices, and embedded applications. Some examples of handheld devices include cellular phones, Internet protocol devices, digital cameras, personal digital assistants (PDAs), and handheld PCs. Embedded applications typically include a microcontroller, a digital signal processor (DSP), a system on a chip, network computers (NetPC), set-top boxes, network hubs, wide area network (WAN) switches, or any other system that can perform the functions and operations taught below. Moreover, the apparatus', methods, and systems described herein are not limited to physical computing devices, but may also relate to software optimizations for energy conservation and efficiency. As will become readily apparent in the description below, the embodiments of methods, apparatus', and systems described herein (whether in reference to hardware, firmware, software, or a combination thereof) are vital to a ‘green technology’ future balanced with performance considerations.

As computing systems are advancing, the components therein are becoming more complex. As a result, the interconnect architecture to couple and communicate between the components is also increasing in complexity to ensure bandwidth requirements are met for optimal component operation. Furthermore, different market segments demand different aspects of interconnect architectures to suit the market's needs. For example, servers require higher performance, while the mobile ecosystem is sometimes able to sacrifice overall performance for power savings. Yet, it's a singular purpose of most fabrics to provide highest possible performance with maximum power saving. Below, a number of interconnects are discussed, which would potentially benefit from aspects of the invention described herein.

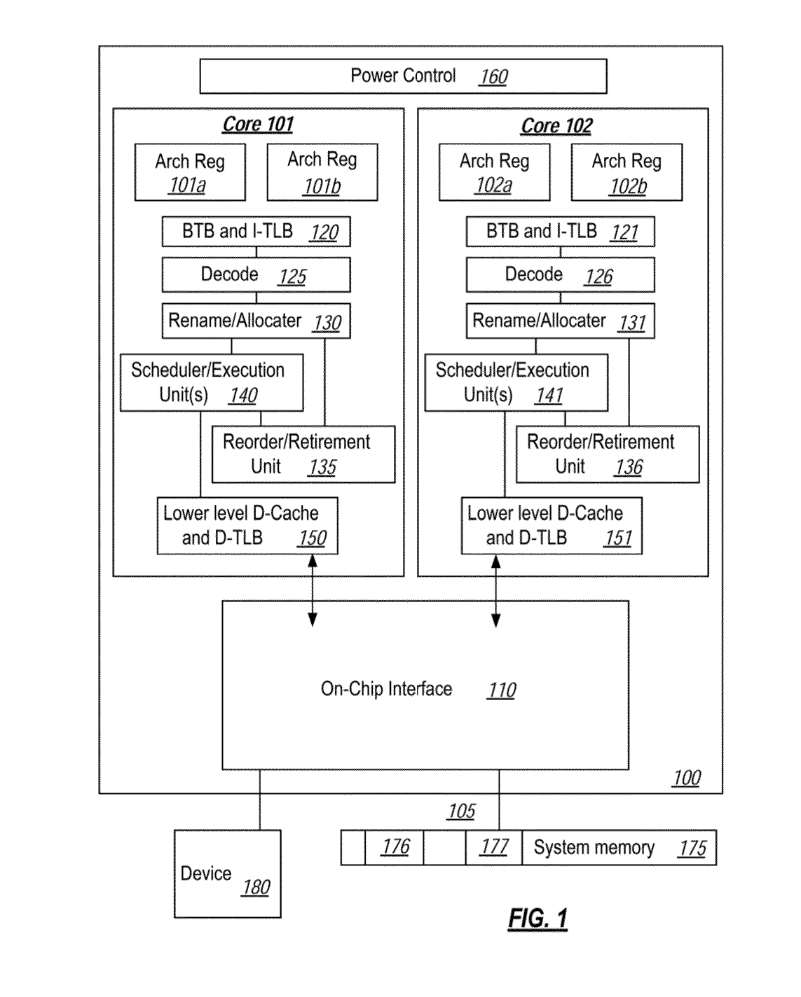

Referring to FIG. 1, an embodiment of a block diagram for a computing system including a multicore processor is depicted. Processor 100 includes any processor or processing device, such as a microprocessor, an embedded processor, a digital signal processor (DSP), a network processor, a handheld processor, an application processor, a co-processor, a system on a chip (SOC), or other device to execute code. Processor 100, in one embodiment, includes at least two cores—core 101 and 102, which may include asymmetric cores or symmetric cores (the illustrated embodiment). However, processor 100 may include any number of processing elements that may be symmetric or asymmetric.

In one embodiment, a processing element refers to hardware or logic to support a software thread. Examples of hardware processing elements include: a thread unit, a thread slot, a thread, a process unit, a context, a context unit, a logical processor, a hardware thread, a core, and/or any other element, which is capable of holding a state for a processor, such as an execution state or architectural state. In other words, a processing element, in one embodiment, refers to any hardware capable of being independently associated with code, such as a software thread, operating system, application, or other code. A physical processor (or processor socket) typically refers to an integrated circuit, which potentially includes any number of other processing elements, such as cores or hardware threads.

A core often refers to logic located on an integrated circuit capable of maintaining an independent architectural state, wherein each independently maintained architectural state is associated with at least some dedicated execution resources. In contrast to cores, a hardware thread typically refers to any logic located on an integrated circuit capable of maintaining an independent architectural state, wherein the independently maintained architectural states share access to execution resources. As can be seen, when certain resources are shared and others are dedicated to an architectural state, the line between the nomenclature of a hardware thread and core overlaps. Yet often, a core and a hardware thread are viewed by an operating system as individual logical processors, where the operating system is able to individually schedule operations on each logical processor.

Physical processor 100, as illustrated in FIG. 1, includes two cores—core 101 and 102. Here, core 101 and 102 can be considered symmetric cores, i.e. cores with the same configurations, functional units, and/or logic. In another embodiment, core 101 includes an out-of-order processor core, while core 102 includes an in-order processor core. However, cores 101 and 102 may be individually selected from any type of core, such as a native core, a software managed core, a core adapted to execute a native Instruction Set Architecture (ISA), a core adapted to execute a translated Instruction Set Architecture (ISA), a co-designed core, or other known core. In a heterogeneous core environment (i.e. asymmetric cores), some form of translation, such a binary translation, may be utilized to schedule or execute code on one or both cores. Yet to further the discussion, the functional units illustrated in core 101 are described in further detail below, as the units in core 102 operate in a similar manner in the depicted embodiment.

As depicted, core 101 includes two hardware threads 101a and 101b, which may also be referred to as hardware thread slots 101a and 101b. Therefore, software entities, such as an operating system, in one embodiment potentially view processor 100 as four separate processors, i.e., four logical processors or processing elements capable of executing four software threads concurrently. As alluded to above, a first thread is associated with architecture state registers 101a, a second thread is associated with architecture state registers 101b, a third thread may be associated with architecture state registers 102a, and a fourth thread may be associated with architecture state registers 102b. Here, each of the architecture state registers (101a, 101b, 102a, and 102b) may be referred to as processing elements, thread slots, or thread units, as described above. As illustrated, architecture state registers 101a are replicated in architecture state registers 101b, so individual architecture states/contexts are capable of being stored for logical processor 101a and logical processor 101b. In cores 101, 102, other smaller resources, such as instruction pointers and renaming logic in allocator and renamer block 130, 131 may also be replicated for threads 101a and 101b and 102a and 102, respectively. Some resources, such as re-order buffers in reorder/retirement unit 135, 136, ILTB 120, 121, load/store buffers, and queues may be shared through partitioning. Other resources, such as general purpose internal registers, page-table base register(s), low-level data-cache and data-TLB 150, 151 execution unit(s) 140, 141 and portions of out-of-order unit are potentially fully shared.

Processor 100 often includes other resources, which may be fully shared, shared through partitioning, or dedicated by/to processing elements. In FIG. 1, an embodiment of a purely exemplary processor with illustrative logical units/resources of a processor is illustrated. Note that a processor may include, or omit, any of these functional units, as well as include any other known functional units, logic, or firmware not depicted. As illustrated, core 101 includes a simplified, representative out-of-order (OOO) processor core. But an in-order processor may be utilized in different embodiments. The OOO core includes a branch target buffer 120 to predict branches to be executed/taken and an instruction-translation buffer (I-TLB) 120 to store address translation entries for instructions.

Core 101 further includes decode module 125 coupled to fetch unit to decode fetched elements. Fetch logic, in one embodiment, includes individual sequencers associated with thread slots 101a, 101b, respectively. Usually core 101 is associated with a first ISA, which defines/specifies instructions executable on processor 100. Often machine code instructions that are part of the first ISA include a portion of the instruction (referred to as an opcode), which references/specifies an instruction or operation to be performed. Decode logic 125 includes circuitry that recognizes these instructions from their opcodes and passes the decoded instructions on in the pipeline for processing as defined by the first ISA. For example, as discussed in more detail below decoders 125, in one embodiment, include logic designed or adapted to recognize specific instructions, such as transactional instruction. As a result of the recognition by decoders 125, the architecture or core 101 takes specific, predefined actions to perform tasks associated with the appropriate instruction. It is important to note that any of the tasks, blocks, operations, and methods described herein may be performed in response to a single or multiple instructions; some of which may be new or old instructions. Note decoders 126, in one embodiment, recognize the same ISA (or a subset thereof). Alternatively, in a heterogeneous core environment, decoders 126 recognize a second ISA (either a subset of the first ISA or a distinct ISA).

In one example, allocator and renamer block 130 includes an allocator to reserve resources, such as register files to store instruction processing results. However, threads 101a and 101b are potentially capable of out-of-order execution, where allocator and renamer block 130 also reserves other resources, such as reorder buffers to track instruction results. Unit 130 may also include a register renamer to rename program/instruction reference registers to other registers internal to processor 100. Reorder/retirement unit 135 includes components, such as the reorder buffers mentioned above, load buffers, and store buffers, to support out-of-order execution and later in-order retirement of instructions executed out-of-order.

Scheduler and execution unit(s) block 140, in one embodiment, includes a scheduler unit to schedule instructions/operation on execution units. For example, a floating point instruction is scheduled on a port of an execution unit that has an available floating point execution unit. Register files associated with the execution units are also included to store information instruction processing results. Exemplary execution units include a floating point execution unit, an integer execution unit, a jump execution unit, a load execution unit, a store execution unit, and other known execution units.

Lower level data cache and data translation buffer (D-TLB) 150 are coupled to execution unit(s) 140. The data cache is to store recently used/operated on elements, such as data operands, which are potentially held in memory coherency states. The D-TLB is to store recent virtual/linear to physical address translations. As a specific example, a processor may include a page table structure to break physical memory into a plurality of virtual pages.

Here, cores 101 and 102 share access to higher-level or further-out cache, such as a second level cache associated with on-chip interface 110. Note that higher-level or further-out refers to cache levels increasing or getting further way from the execution unit(s). In one embodiment, higher-level cache is a last-level data cache—last cache in the memory hierarchy on processor 100—such as a second or third level data cache. However, higher level cache is not so limited, as it may be associated with or include an instruction cache. A trace cache—a type of instruction cache—instead may be coupled after decoder 125 to store recently decoded traces. Here, an instruction potentially refers to a macro-instruction (i.e. a general instruction recognized by the decoders), which may decode into a number of micro-instructions (micro-operations).

In the depicted configuration, processor 100 also includes on-chip interface module 110. Historically, a memory controller, which is described in more detail below, has been included in a computing system external to processor 100. In this scenario, on-chip interface 11 is to communicate with devices external to processor 100, such as system memory 175, a chipset (often including a memory controller hub to connect to memory 175 and an I/O controller hub to connect peripheral devices), a memory controller hub, a northbridge, or other integrated circuit. And in this scenario, bus 105 may include any known interconnect, such as multi-drop bus, a point-to-point interconnect, a serial interconnect, a parallel bus, a coherent (e.g. cache coherent) bus, a layered protocol architecture, a differential bus, and a GTL bus.

Memory 175 may be dedicated to processor 100 or shared with other devices in a system. Common examples of types of memory 175 include DRAM, SRAM, non-volatile memory (NV memory), and other known storage devices. Note that device 180 may include a graphic accelerator, processor or card coupled to a memory controller hub, data storage coupled to an I/O controller hub, a wireless transceiver, a flash device, an audio controller, a network controller, or other known device.

Recently however, as more logic and devices are being integrated on a single die, such as SOC, each of these devices may be incorporated on processor 100. For example in one embodiment, a memory controller hub is on the same package and/or die with processor 100. Here, a portion of the core (an on-core portion) 110 includes one or more controller(s) for interfacing with other devices such as memory 175 or a graphics device 180. The configuration including an interconnect and controllers for interfacing with such devices is often referred to as an on-core (or un-core configuration). As an example, on-chip interface 110 includes a ring interconnect for on-chip communication and a high-speed serial point-to-point link 105 for off-chip communication. Yet, in the SOC environment, even more devices, such as the network interface, co-processors, memory 175, graphics processor 180, and any other known computer devices/interface may be integrated on a single die or integrated circuit to provide small form factor with high functionality and low power consumption.

In one embodiment, processor 100 is capable of executing a compiler, optimization, and/or translator code 177 to compile, translate, and/or optimize application code 176 to support the apparatus and methods described herein or to interface therewith. A compiler often includes a program or set of programs to translate source text/code into target text/code. Usually, compilation of program/application code with a compiler is done in multiple phases and passes to transform hi-level programming language code into low-level machine or assembly language code. Yet, single pass compilers may still be utilized for simple compilation. A compiler may utilize any known compilation techniques and perform any known compiler operations, such as lexical analysis, preprocessing, parsing, semantic analysis, code generation, code transformation, and code optimization.

Larger compilers often include multiple phases, but most often these phases are included within two general phases: (1) a front-end, i.e. generally where syntactic processing, semantic processing, and some transformation/optimization may take place, and (2) a back-end, i.e. generally where analysis, transformations, optimizations, and code generation takes place. Some compilers refer to a middle, which illustrates the blurring of delineation between a front-end and back end of a compiler. As a result, reference to insertion, association, generation, or other operation of a compiler may take place in any of the aforementioned phases or passes, as well as any other known phases or passes of a compiler. As an illustrative example, a compiler potentially inserts operations, calls, functions, etc. in one or more phases of compilation, such as insertion of calls/operations in a front-end phase of compilation and then transformation of the calls/operations into lower-level code during a transformation phase. Note that during dynamic compilation, compiler code or dynamic optimization code may insert such operations/calls, as well as optimize the code for execution during runtime. As a specific illustrative example, binary code (already compiled code) may be dynamically optimized during runtime. Here, the program code may include the dynamic optimization code, the binary code, or a combination thereof.

Similar to a compiler, a translator, such as a binary translator, translates code either statically or dynamically to optimize and/or translate code. Therefore, reference to execution of code, application code, program code, or other software environment may refer to: (1) execution of a compiler program(s), optimization code optimizer, or translator either dynamically or statically, to compile program code, to maintain software structures, to perform other operations, to optimize code, or to translate code; (2) execution of main program code including operations/calls, such as application code that has been optimized/compiled; (3) execution of other program code, such as libraries, associated with the main program code to maintain software structures, to perform other software related operations, or to optimize code; or (4) a combination thereof.

Example interconnect fabrics and protocols can include such examples a Peripheral Component Interconnect (PCI) Express (PCIe) architecture, Intel QuickPath Interconnect (QPI) architecture, Mobile Industry Processor Interface (MIPI), among others. A range of supported processors may be reached through use of multiple domains or other interconnects between node controllers.

An interconnect fabric architecture can include a definition of a layered protocol architecture. In one embodiment, protocol layers (coherent, non-coherent, and optionally other memory based protocols), a routing layer, a link layer, and a physical layer can be provided. Furthermore, the interconnect can include enhancements related to power managers, design for test and debug (DFT), fault handling, registers, security, etc.

The physical layer of an interconnect fabric, in one embodiment, can be responsible for the fast transfer of information on the physical medium (electrical or optical etc.). The physical link is point to point between two Link layer entities. The Link layer can abstract the Physical layer from the upper layers and provide the capability to reliably transfer data (as well as requests) and manage flow control between two directly connected entities. It also is responsible for virtualizing the physical channel into multiple virtual channels and message classes. The Protocol layer can rely on the Link layer to map protocol messages into the appropriate message classes and virtual channels before handing them to the Physical layer for transfer across the physical links. Link layer may support multiple messages, such as a request, snoop, response, writeback, non-coherent data, etc.

In some implementations, a Link layer can utilize a credit scheme for flow control. Non-credited flows can also be supported. With regard to credited flows, during initialization, a sender is given a set number of credits to send packets or flits to a receiver. Whenever a packet or flit is sent to the receiver, the sender decrements its credit counters by one credit which represents either a packet or a flit, depending on the type of virtual network being used. Whenever a buffer is freed at the receiver, a credit is returned back to the sender for that buffer type. When the sender's credits for a given channel have been exhausted, in one embodiment, it stops sending any flits in that channel. Essentially, credits are returned after the receiver has consumed the information and freed the appropriate buffers.

In one embodiment, routing layer can provide a flexible and distributed way to route packets from a source to a destination. In some platform types (for example, uniprocessor and dual processor systems), this layer may not be explicit but could be part of the Link layer; in such a case, this layer is optional. It relies on the virtual network and message class abstraction provided by the Link Layer as part of the function to determine how to route the packets. The routing function, in one implementation, is defined through implementation specific routing tables. Such a definition allows a variety of usage models.

In one embodiment, protocol layer can implement the communication protocols, ordering rule, and coherency maintenance, I/O, interrupts, and other higher-level communication. Note that protocol layer, in one implementation, can provide messages to negotiate power states for components and the system. As a potential addition, physical layer may also independently or in conjunction set power states of the individual links.

Multiple agents may be connected to an interconnect architecture, such as a home agent (orders requests to memory), caching (issues requests to coherent memory and responds to snoops), configuration (deals with configuration transactions), interrupt (processes interrupts), legacy (deals with legacy transactions), non-coherent (deals with non-coherent transactions), and others.

Processors continue to improve their performance capabilities and, as a result, demand more bandwidth per core. These advancements further test interconnect architectures in that latency of the multi-core system can suffer as additional cores are added to an on-chip design. A variety of architectures have been developed in anticipation of the growth in core performance and count, although some solutions are limited in their ability to scale to growing numbers of cores sharing bandwidth provided through the interconnect. In one example, ring interconnect architectures have been utilized and corresponding protocols and policies have been developed within some environments. Although traditional ring architectures have been successfully implemented in some systems, scaling a ring interconnect architecture (e.g., beyond ten cores) and in multiple dimensions has proven difficult.

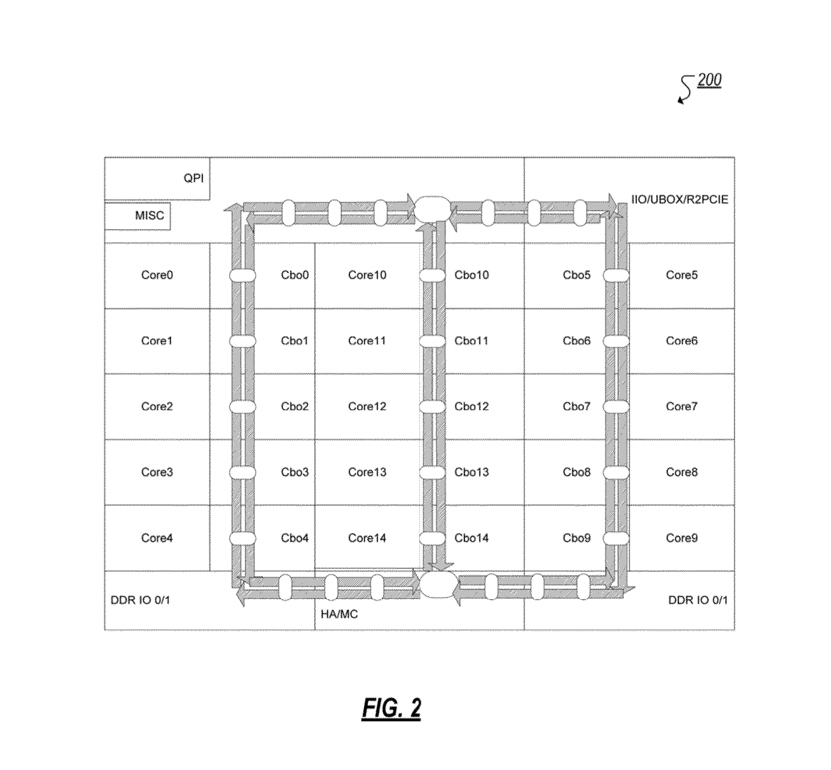

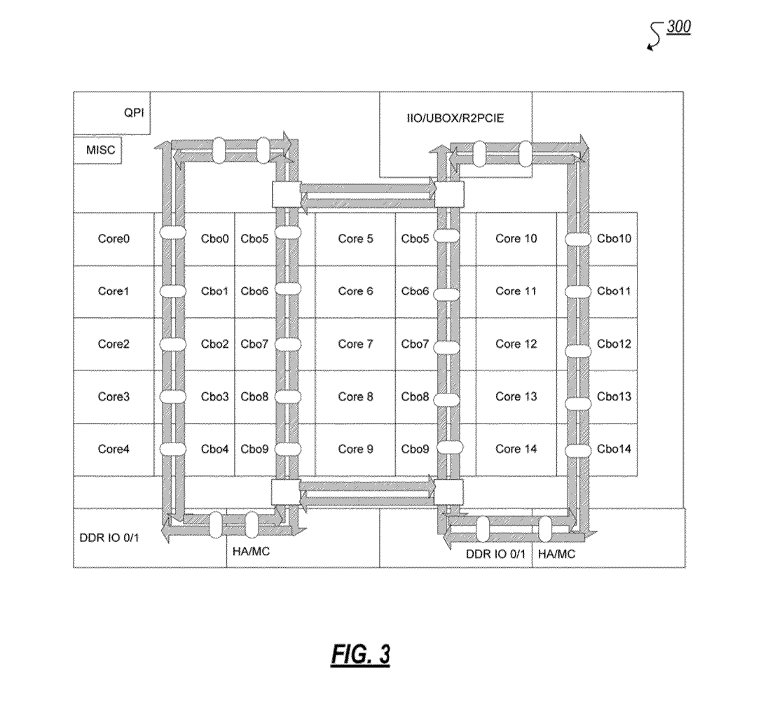

Some solutions seek to combine multiple rings to form an improved ring interconnect architecture. As an example, the simplified block diagram 200 illustrated in the example of FIG. 2 shows a modified ring interconnect architecture incorporating two merged rings. The architecture of the example of FIG. 2 permits scaling of cores (e.g., Cores 0-14) along the vertical axis of the floor plan as with a single ring design as well as some scaling along the horizontal access through the provision of a third column of cores. However, the junction stop provided in the multi-ring design of FIG. 2 that enables transactions of one ring to be routed along the other ring can create bottlenecks and limit the scaling of the design beyond three columns without detrimental effects on performance. In another example, such as illustrated in the block diagram 300 of FIG. 3, another example of a multi-ring interconnect architecture is shown. Here, two parallel rings 305, 310 are provided to extend scaling of the cores in the horizontal direction, however, again, bottlenecks can be introduced through the use of bridge segments 315, 320 linking the two rings 305, 310. For instance, traffic from ring 305 that is destined for a core or cache partition on ring 310 can sink at a stop (e.g., 320, 325) where traffic is to sink to progress toward the other ring 310, among other examples.

A new interconnect architecture can be provided in a multi-core chip that addresses several of the issues introduced above. In one example, a single ring architecture can be expanded to a mesh-style network including a mesh of half- or full-rings in both a vertical and horizontal orientation. Each of the rings can still maintain the general design and protocol and flow control of traditional ring architectures. Indeed, in some implementations, portions of ring architecture protocols and flow control designed for use in traditional or other ring interconnect architectures. For instance, in some implementations, techniques, protocols, algorithms, policies, and other aspects of the subject matter disclosed in a patent application filed Nov. 29, 2011 under the Patent Cooperation Treaty as PCT/US2011/062311, incorporated herein by reference, can be utilized in such “ring mesh” architectures. The mesh-like layout of the architecture can remove bandwidth constraints on orthogonal expansion of the ring (e.g., as in the examples of FIGS. 2 and 3) while maintaining a close to direct-path latency. Each tile (including a core) can include an agent or ring stop with a connection to both one of the horizontally-oriented rings and one of the vertically-oriented rings, the ring stop further functioning as the cross-over point from the horizontally-oriented ring to the vertically-oriented ring connected to the ring stop.

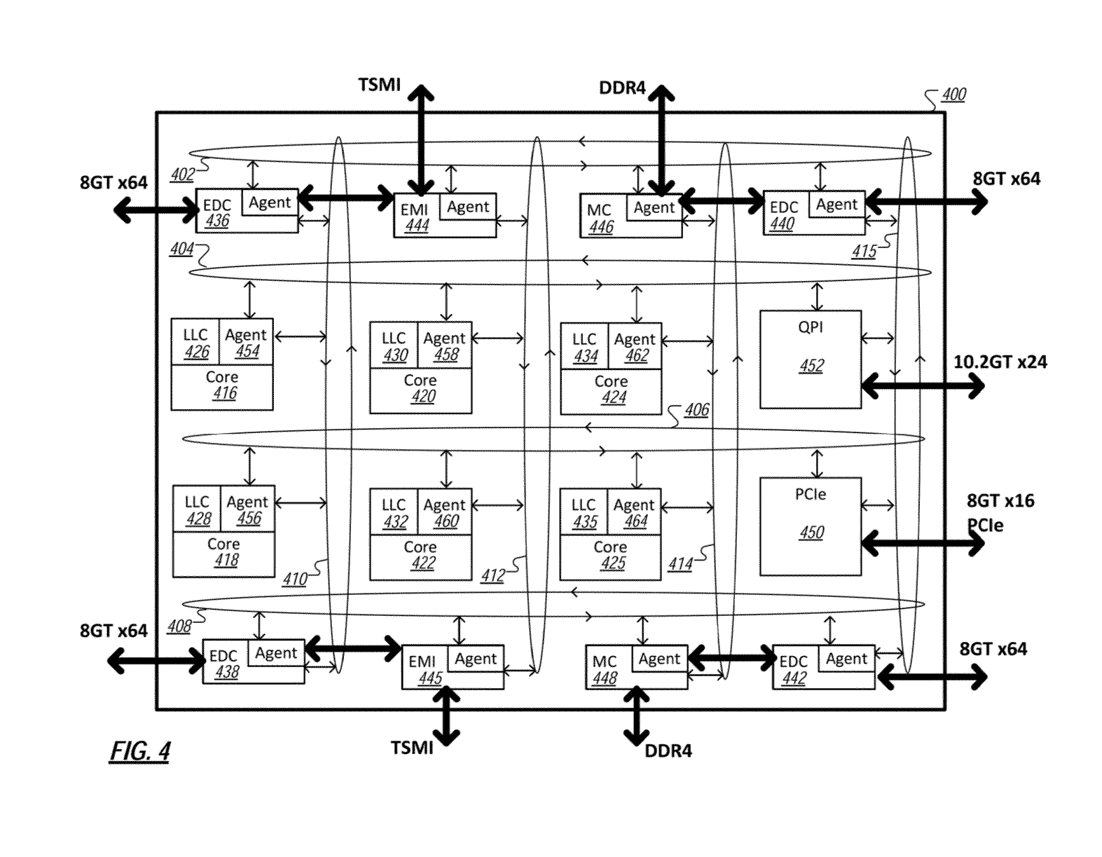

A simplified representation of an improved ring mesh interconnect architecture is illustrated in the example block diagram of FIG. 4. A chip 400 is represented including a mesh of horizontally-oriented (relative to the angle of presentation in FIG. 4) ring interconnect segments 402, 404, 406, 408 and vertically-oriented ring interconnect segments 410, 412, 414, 415. A plurality of tiles can be provided, at least some of which including one of a plurality of processing cores 416, 418, 420, 422, 424, 425 and portions or partitions of a last-level cache (LLC) 426, 428, 430, 432, 434, 435. Additional components, such as memory controllers and memory interfaces, can also be provided such as an embedded DRAM controller (EDC), an external memory controller interface (EMI) (e.g., 444, 445), memory controllers (e.g., 446, 448), and interdevice interconnect components such as a PCIe controller 450 and QPI controller 452, among other examples. Agents (e.g., 454, 456, 458, 460, 462, 464) and other logic can be provided to serve as ring stops for the components (e.g., 416, 418, 420, 422, 424, 425, 426, 428, 430, 432, 434, 435, 436, 438, 440, 442, 444, 445, 446, 448, 450, 452) to connect each component to one horizontally oriented ring and one vertically oriented ring. For instance, each tile corresponding to a core (e.g., 416, 418, 420, 422, 424, 425) can correspond to an intersection of a horizontally oriented ring and a vertically oriented ring in the mesh. For instance, agent 456 corresponding to core 422 and the cache box (e.g., 432) of a last level cache segment collocated on the tile of core 422 can serve as a ring stop for both horizontally oriented ring 406 and vertically oriented ring 412.

A ring mesh architecture, such as represented in the example of FIG. 4, can leverage a ring architecture design and provide greater and more flexibility along with higher performance, among other potential example advantages. Ring stops can send transactions on both a horizontally oriented and a vertically oriented ring. Each ring stop can also be responsible for sinking a message for one ring and injecting to another (i.e., orthogonally oriented) ring. Once injected onto a ring, message do not stop at each intermediate ring stop but instead progress along the ring until reaching a traverse or destination ring stop. A message, at a traverse ring stop for a particular path, can traverse from a horizontally oriented to a vertically oriented ring (or vice versa). The message can be buffered at this traverse ring stop where it is re-injected onto the mesh (i.e., on another ring), where the message progresses non-stop (i.e., passing over intermediate rings) until it reaches its destination (or another traversal point (e.g., in connection with dynamic re-routing of the message, etc.)).

In some implementations, ring stops of the on-chip tiles can be included in connection with an agent (e.g., 454, 456, 458, 460, 462, 464) for the tile. The agent (e.g., 454, 456, 458, 460, 462, 464), in some implementations, can be a combined agent for the core and cache bank of a tile. In one example, the agent can include the functionality of a cache agent managing access to system cache and a home agent managing access to system memory, among other features and examples. In other implementations, home and cache agents can be provided for separately and distinct from a ring stop connecting the tile to rings of a ring mesh interconnect, among other examples and implementations.

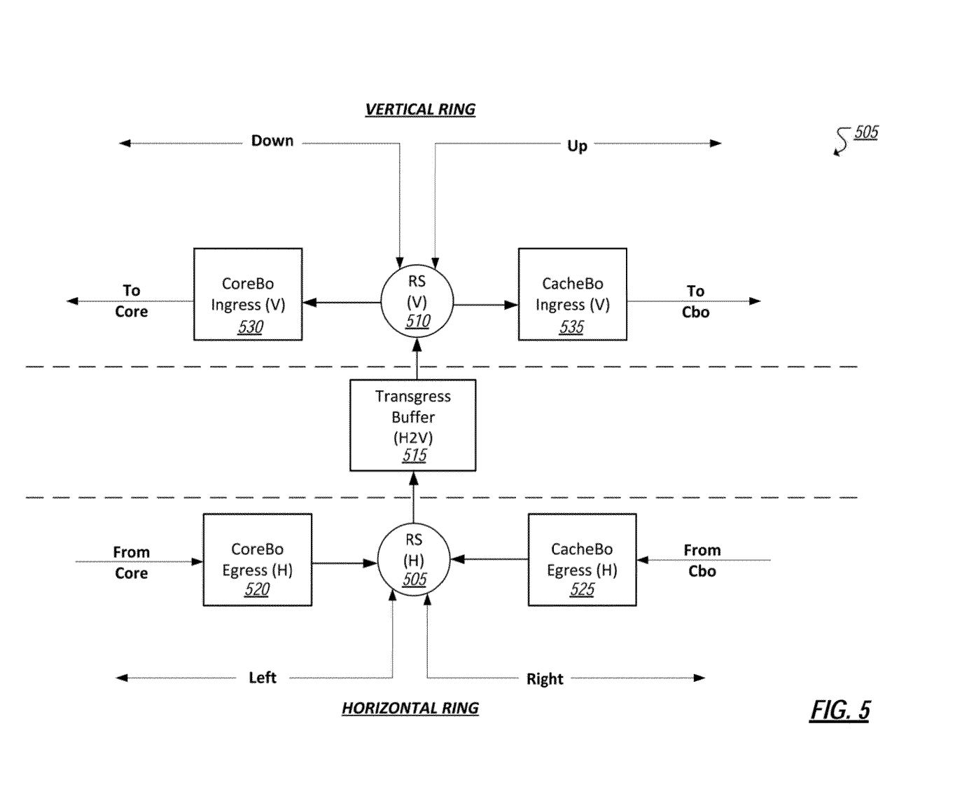

Turning to FIG. 5, a simplified block diagram is shown of an example implementation of a ring stop 500 for use in an example ring mesh architecture. In the particular example of FIG. 5, the ring stop 500 includes a horizontal ring-stop component 505, vertical ring-stop component 510, and transgress buffer 515. Horizontal ring-stop component 505 can include logic for routing, buffering, transmitting, and managing traffic that enters from and exits to the horizontal ring interconnect with which the ring stop agent 500 is connected. Similarly, vertical ring-stop component 510 can include logic for the routing and transmission routing buffering, transmitting, and managing traffic that enters from and exits to the vertically-oriented ring interconnect with which the ring stop agent 500 is connected. The transgress buffer 515 can include logic for transitioning messages from one of the ring interconnects (i.e., the horizontally-oriented or vertically-oriented ring) connected to the ring stop 500 to the other (i.e., the vertically-oriented or horizontally-oriented ring).

In one implementation, transgress buffer 515 can buffer messages transitioning from one ring to the other and manage policies and protocols applicable to these transitions. Arbitration of messages can be performed by the transgress buffer 515 according to one or more policies. In one example, transgress buffer 515 includes an array of credited/non-credited queues to sink ring traffic from one ring and inject the traffic to the other ring connected to the ring stop of a particular tile. The buffer size of the transgress buffer 515 can be defined based on the overall performance characteristics, the workload, and traffic patterns of a particular ring mesh interconnect, among other examples. Further, as messages already on a given ring of the ring mesh are to proceed unimpeded to their destination or transition point, messages already on the ring have priority and the transgress buffer 515 can monitor traffic on the rings to which it is connected and inject traffic when available bandwidth is discovered on the appropriate ring. In one example, transgress buffer 515 can apply anti-starvation policies to traffic arbitrated by the transgress buffer 515. In one example, each transaction can be limited to passing through a given transgress buffer exactly once on its path through the interconnect. This can further simplify implementation of protocols utilized by the transgress buffer 515 to effectively connect or bridge rings within the mesh governed by more traditional ring interconnect policies and protocols, including flow control, message class, and other policies.

In some implementations, a ring mesh interconnect, such as that described herein, can exhibit improved bandwidth and latency characteristics. In one examples, agents of the interconnect can inject traffic onto a source ring (e.g., onto a horizontal ring in a system with horizontal-to-vertical transitions) as long as there is no pass-through traffic coming from adjacent ring-stops. The priority between the agents for injecting can be round-robin. In a unidirectional design, agents can further inject directly to the sink ring (e.g., a vertical ring in a system with horizontal-to-vertical transitions) as long as there are no packets switching at the transgress buffer (from the horizontal ring to the vertical ring) and there is no pass-through traffic. Agents can sink directly from the sink ring. Polarity rules on the sink ring can guarantee that only a single packet is sent to each agent in a given clock on the sink ring. If there are no packets to sink from the sink ring in a unidirectional design, the agents can then sink from either the transgress buffer (e.g., previously buffered packets from the source ring) or the source ring directly (e.g., through a transgress buffer bypass or other co-located bypass path). In such instances, the source ring does not need any polarity rules as the transgress buffer can be assumed to be dual-ported and can sink two packets every cycle. For instance, a transgress buffer can have two or more read ports and two or more write ports. Further, even packets destined to sink into agents on a source ring can be buffered in the corresponding transgress buffer where desired, among other examples.

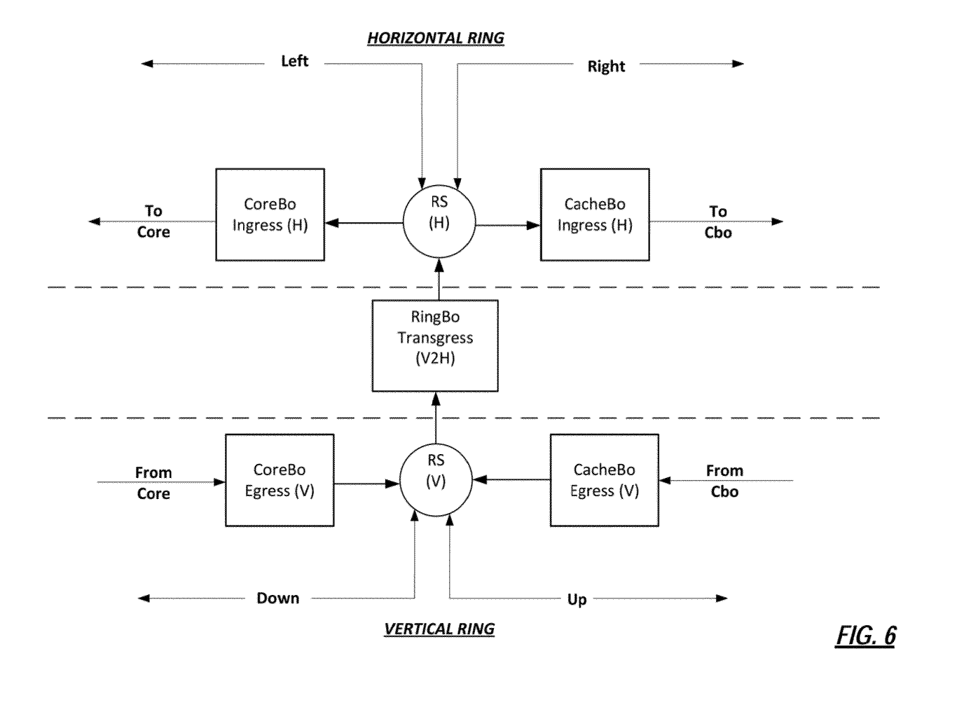

In some implementations, transgress buffer 515 can be bi-directional in that the transgress buffer 515 sinks traffic from either of the horizontally-oriented and vertically-oriented rings connected to the ring stop 500 and inject the traffic on the other ring. In other implementations, however, transgress buffer 515 can be unidirectional, such as illustrated in the example of FIG. 5. In this particular example ring mesh transfers transfer from the horizontal ring of a ring stop to the vertical ring of a ring stop. Accordingly, traffic originating from a horizontal ring can be routed through the horizontal ring stop component through the transgress buffer 515 to the vertical ring stop component 510 for injection on the vertical ring connected to the ring stop 500 or for sending to the core box ingress 530 of the core or cache box ingress 535 of the portion of LLC at the tile to which ring stop 500 belongs. Messages sent from the core or cache box of the tile of ring stop 500 can be sent via a core box (or agent) egress (520) or cache box (or agent) egress (525) connected to the horizontal ring stop component 505 in this particular implementation. Further, messages received by the core or LLC of the tile can be handled by the core box ingress 530 or cache box ingress 535 connected to the vertical ring stop component 510. Dedicated connections can be provided from the core and cache boxes and the ring stop 500. While the example of FIG. 5 illustrates one example implementation according to a unidirectional, horizontal-to-vertical ring transition design, other alternatives can be utilized, such as the bidirectional design introduced above, as well as a unidirectional, vertical-to-horizontal ring transition design illustrated in the example of FIG. 6.

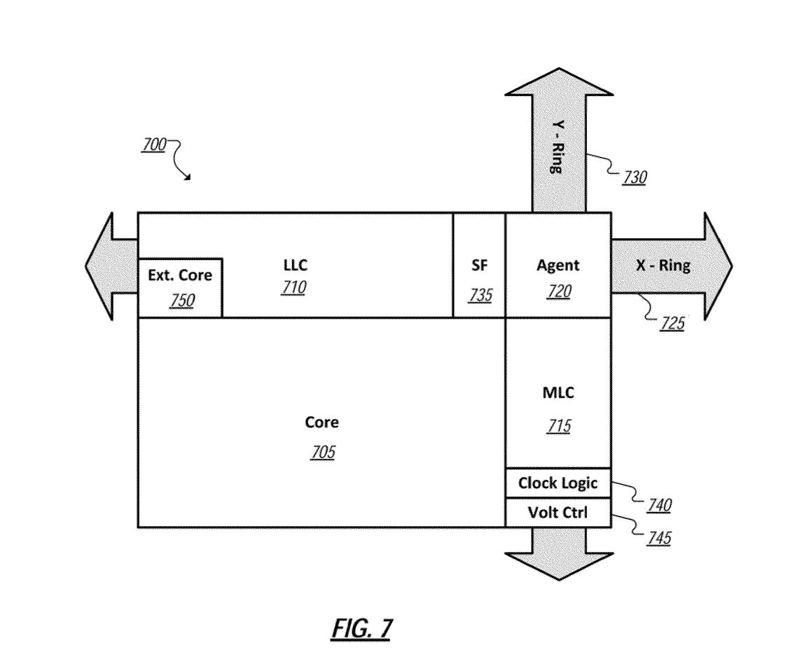

FIG. 7 illustrates a block diagram illustrating a simplified representation of the on-chip layout of a tile 700 included in a multi-core device utilizing a ring mesh interconnect according to principles and features described herein. In one example, a tile 700 can include a CPU core 705, partition of a cache including a last level cache (LLC) 710 and mid-level cache 715, among other examples. An agent 720 can be provided including a ring stop positioned so as to connect to two rings 725, 730 in the ring mesh. A transgress buffer of the ring stop can permit messages to transition from one of the rings (e.g., 725) to the other of the rings (e.g., 730). Each ring (e.g., 725, 730) can include multiple wires. In some implementations, the on-die wires of the ring mesh can be run on top of or beneath at least a portion of the tiles on the die. Some portions of the core can be deemed “no-fly” zones, in that no wires are to be positioned on those portions of the silicon utilized to implement the core. For instance, in the example of FIG. 7, rings 725, 730 are laid out on the die such that they are not positioned on or interfere with the core 705. Wire of the rings 725, 730 can instead by positioned over other components on the tile, including LLC 710, MLC 715, and agent 720, among other components on the tile, including for example, a snoop filter 735, clocking logic, voltage regulation and control components (e.g., 745), and even some portions of the core (e.g., 750) less sensitive to the proximity of the wires of a ring mesh interconnect, among other examples.

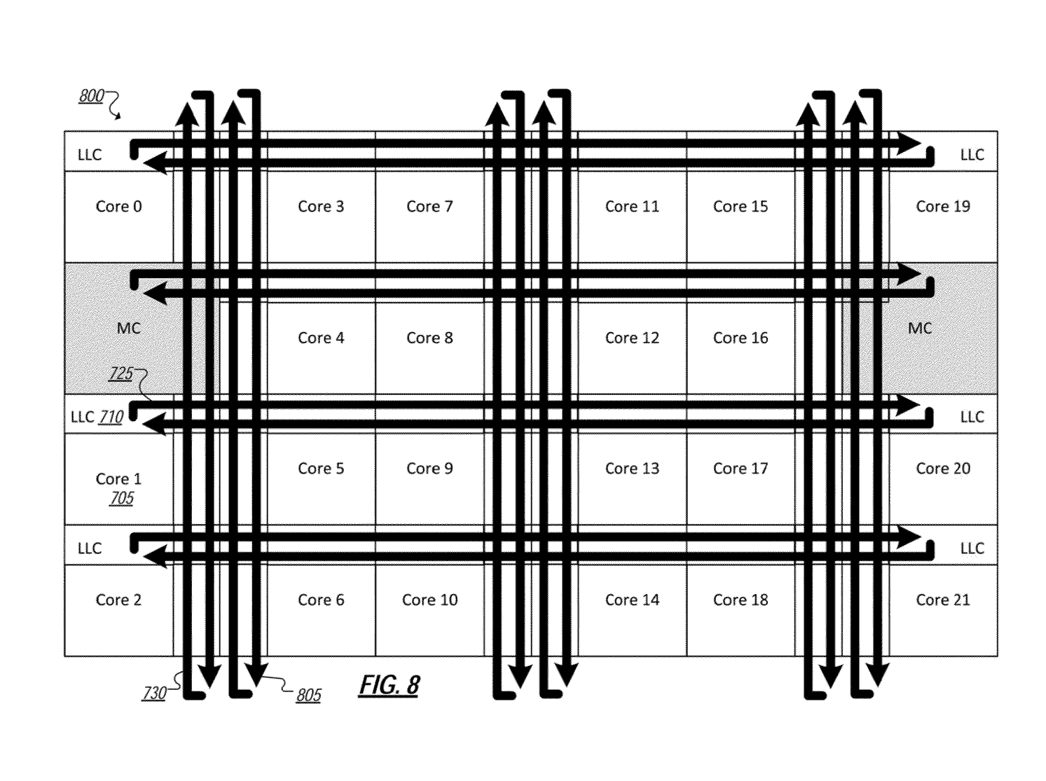

FIG. 8 represent an example floor plan 800 of a simplified multi-core device utilizing a ring mesh interconnect. A ring mesh interconnect conveniently allows scaling of a multi-core design in both the vertical (y-axis) and horizontal (x-axis) dimension. Four or more columns can be provided with multiple cores (and tiles) per column. In some implementations, a multi-core device utilizing a ring mesh interconnect can expand to upwards of twenty cores. Accordingly, a variety of multi-core floor plans can be realized using ring mesh style interconnects while maintaining bandwidth and low latency characteristics.

As noted, for instance, in the discussion of the example of FIG. 7, each tile in floor plan 800 can include a core (e.g., 705) and a cache bank and corresponding cache controller (e.g., 710). Further, to assist in minimizing the costs of the ring mesh interconnect, wires of the rings (e.g., 725, 730) can be positioned over a portion of each tile allowing the tiles to be tightly grouped on the device, making more efficient use of the die area. An agent for each tile can include a ring stop connecting the tile to two of the rings in the mesh. The ring stop can be positioned at a corner of the tile in some implementations. In the particular example of FIG. 8, columns of tiles can alternate placement of the ring stop on the tile, allowing for neighboring vertical rings (e.g., 730, 805) to be positioned on the adjoining sides of the columns. Two columns of cores (e.g., 810, 815) can then be provided the next set of two substantially adjacent vertical rings (e.g., 820, 825), and so on. In some implementations, providing for some of the ring mesh rings to be substantially adjacent on the die can allow for power delivery and clocking architecture to be shared on two adjacent columns (or rows), among other example benefits and implementations. As noted above, ring mesh-style interconnects permit flexibility in realizing a variety of different floor plan layouts. Accordingly, it should be appreciated that the simplified example of FIG. 8 is but one representative example of a floor plan employing a ring mesh interconnect and a wide variety of alternative designs with more or fewer tiles, different components, different placement of agents and rings, etc. can be provided.

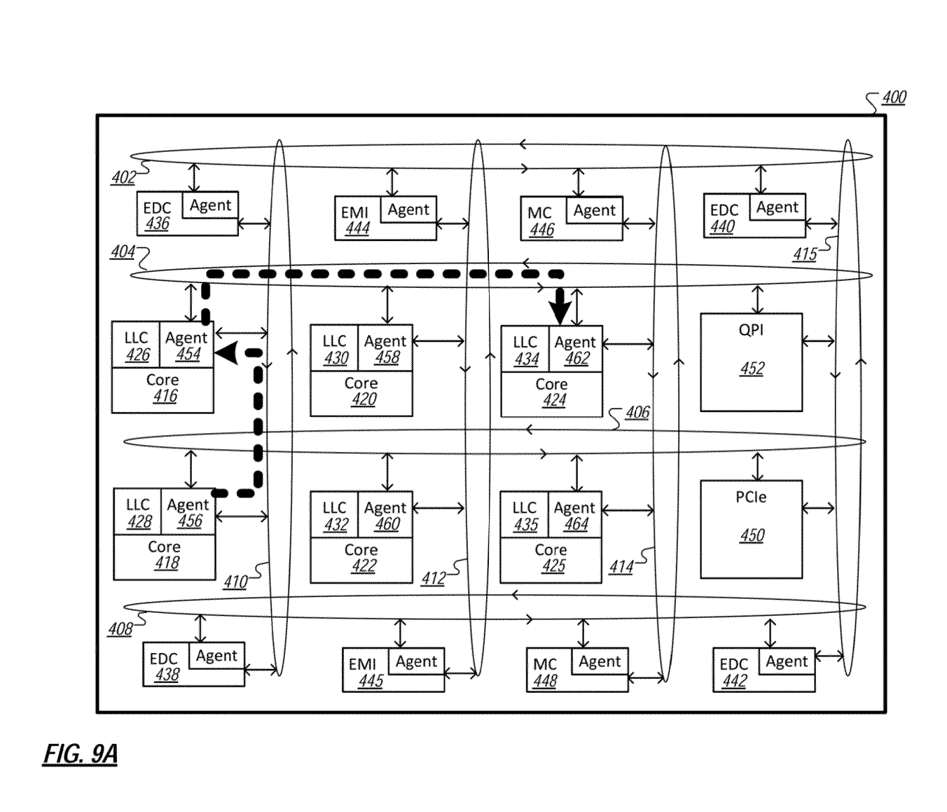

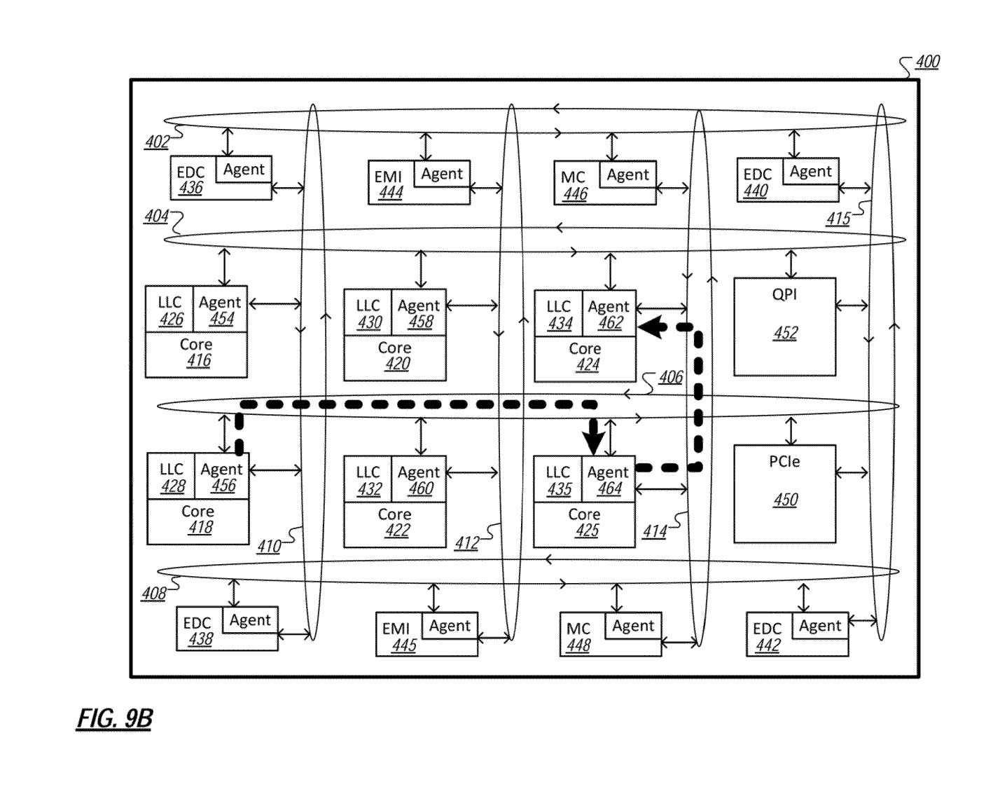

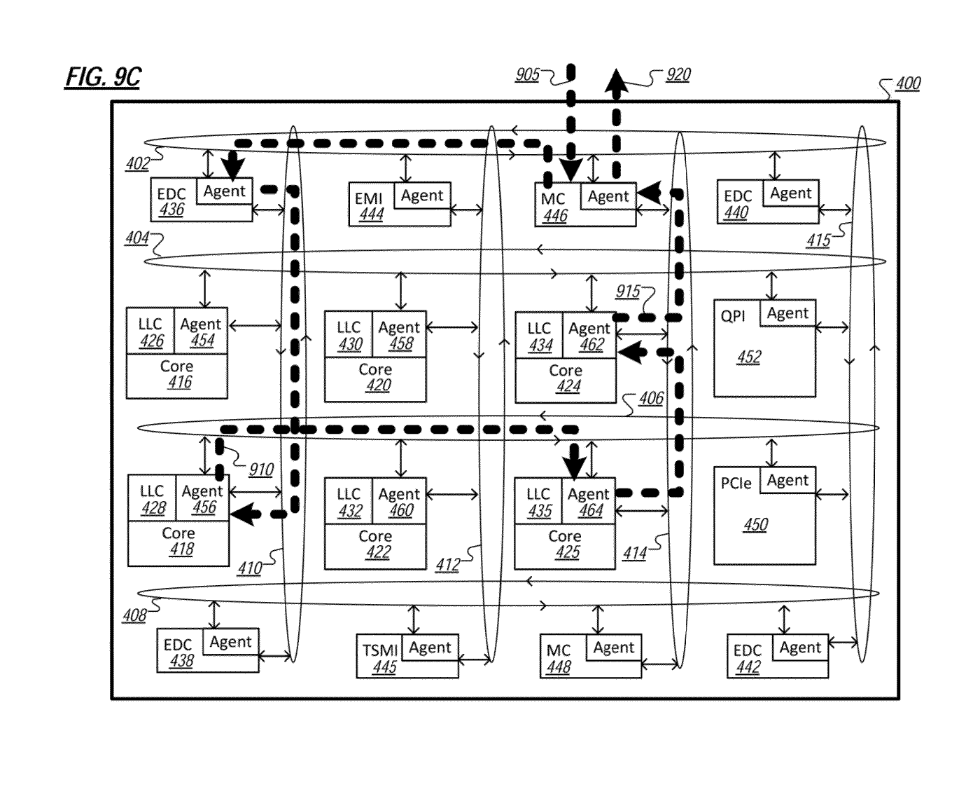

FIGS. 9A-9C illustrate example flows that can be realized using various implementations of a ring mesh interconnect connecting a plurality of CPU core tiles. In the following simplified examples, the example device 400 (introduced in FIG. 4) is presented to represent example flows between components (e.g., 416, 418, 420, 422, 424, 425, 426, 428, 430, 432, 434, 435, 436, 438, 440, 442, 444, 445, 446, 448, 450, 452) of the device 400. For instance, in the example of FIG. 9A, a message can be sent from a core 418 to a cache bank 434 on another tile (of core 424) on the device 400. Each cache bank (e.g., 426, 428, 430, 432, 434, 435) can represent a division of the overall cache of the system and each core (e.g., 416, 418, 420, 422, 424, 425) can potentially access and use data in any one of the cache banks of the device 400. An agent 456 of core 418 can be utilized to inject the message traffic on vertical ring 410 destined for agent 462. The message traffic can be routed to agent 454 for transitioning the traffic from ring 410 to horizontal ring 404. In one example, agents 454, 456, 458, 460, 462, 464 can each be configured to provide cross-overs between the respective rings (e.g., 402, 404, 406, 408, 410, 412, 414, 415) either bi-directionally or according to a unidirectional transition. For instance, the example of FIG. 9A could be implemented in a unidirectional configuration with transgress buffers configured to transition traffic from vertical rings to horizontal rings. Agent 454 can transition (e.g., sink traffic from ring 410 and re-inject) the traffic to horizontal ring 404 for transmission to the core of agent 462. Once on the ring 404, the traffic can proceed non-stop to the agent 462 connected to vertical ring 414, effectively passing, unimpeded past intervening vertical rings, such as vertical ring 412. No intermediate buffers or ring stops may be provided at each such “intersections” of vertical and horizontal rings (e.g., rings 404 and 412), allowing traffic on any one of the rings (e.g., 402, 404, 406, 408, 410, 412, 414, 415) to progress uninterrupted to its destination on the ring. Lower latency can be realized over designs employing ring stops at mesh intersections, allowing for a latency profile similar to that of traditional ring interconnects and lower than traditional mesh interconnect designs, while providing a bandwidth profile similar to that of other, a non-ring, mesh interconnects, among other example advantages.

A ring mesh interconnect can provide flexibility, not only in the layout of the die, but also for routing between components on the device. In some implementations, dynamic rerouting of traffic on the ring mesh can be provided, allowing for traffic to be conveniently re-routed to other rings on the mesh to arrive at a particular destination. The example of FIG. 9B illustrates another potential path that can be utilized to transmit traffic on the interconnect from agent 456 to agent 462. In the example of FIG. 9B, agent 456 can inject the traffic on horizontal ring 406 for transmission to agent 464. Agent 464 can transition the traffic (e.g., using a transgress buffer) from horizontal ring 406 to vertical ring 414 for transmission to the destination tile and agent 462. In one implementation, the example flow illustrated in FIG. 9B can be a flow adopted by a ring mesh utilizing unidirectional transgress buffers from horizontal rings to vertical rings. Further, as in the example of FIG. 9A, traffic injected onto the rings can proceed non-stop on the ring utilizing ring interconnect protocols, without sinking to intermediate ring stops of intermediate rings (e.g., 412) over which the traffic passes.

In some implementations, buffering of traffic at a transgress buffer for transitioning from one ring to another can be achieved in as few as a single cycle. By providing for transmission of traffic along a ring of the ring mesh uninterrupted to its destination or next transition point, further latency can be reduced as would be introduced by additional ring stops provided along the horizontal or vertical path of a more traditional mesh interconnect, among other example advantages.

Turning to the example of FIG. 9C, a third example is shown involving a device 400 utilizing a ring mesh interconnect to interconnect multiple CPU cores and cache banks. In the example of FIG. 9C, a request 905 is received (e.g., from another device external to device 400) at memory controller 446 for data stored in a line of last level cache (LLC) of the device 400. The memory controller 446 can route the request to an agent 456 of a cache bank 428 believed to store the requested data. In this particular example, a path can be utilized on the ring mesh that involves first sending the request message over horizontal ring 402 to proceed non-stop to a transgress buffer of EDC component 436 that is to inject the traffic onto vertical ring 404. The traffic can progress non-stop on vertical ring 404 to the destination of the request at agent 456. The path illustrated in the example of FIG. 9C can correspond to an implementation utilizing a horizontal-to-vertical transgress buffer implementation. In other examples, alternate paths can be utilized, including in re-routes of the request, to communicate the request to the agent 456, using potentially, any combination of rings 402, 404, 406, 408, 410, 412, 414, 415.

Continuing with the example of FIG. 9C, agent 456 can be connected to core box 418. The core 418 can process the request and determine that the cache bank 428 does not, in fact, own the requested cache line and can perform a hash function or other look-up to determine which bank of the device cache owns the cache line corresponding to the request 905. The core box 418 can determine that cache bank 434 is instead the correct owner of the requested cache line. Agent 456 can determine a path for forwarding the request to agent 462 corresponding to the cache bank 434. The path, in this example, can again follow a single turn horizontal-to-vertical path, although alternate paths can be utilized, including paths with multiple turns on multiple horizontal and vertical rings. In the illustrated example of FIG. 9C, agent 456 injects 910 the request onto horizontal ring 406 to be transitioned to vertical ring 414 using agent 464. The request proceeds non-stop to agent 464 where it is potentially buffered and then injected onto ring 414 for transmission to its destination, agent 462. The traffic then proceeds to agent 462 along ring 414. Upon receiving the request, core box 424 can process the request to determine whether the requested cache line is present in cache bank 434. If the line is present and other conditions, the core 424 may produce a response to be transmitted to memory controller 446 (or another component) based on the data included in the cache line. In the present example, however, core 424 determines a LLC miss and redirects the request back to system memory to be handled by memory controller 446. Accordingly, the LLC miss response 915 is generated and the agent 462 determines a path on the ring mesh to communicate the response to memory controller 446. In this case, as the memory controller 446 is connected to the same vertical ring as the agent 462, the response progresses on vertical ring 414 to the memory controller 446. The memory controller 446 can process the response and potentially attempt to find the originally requested data in system memory, reply to the requesting component (i.e., of request 905) with an update message, among other examples.

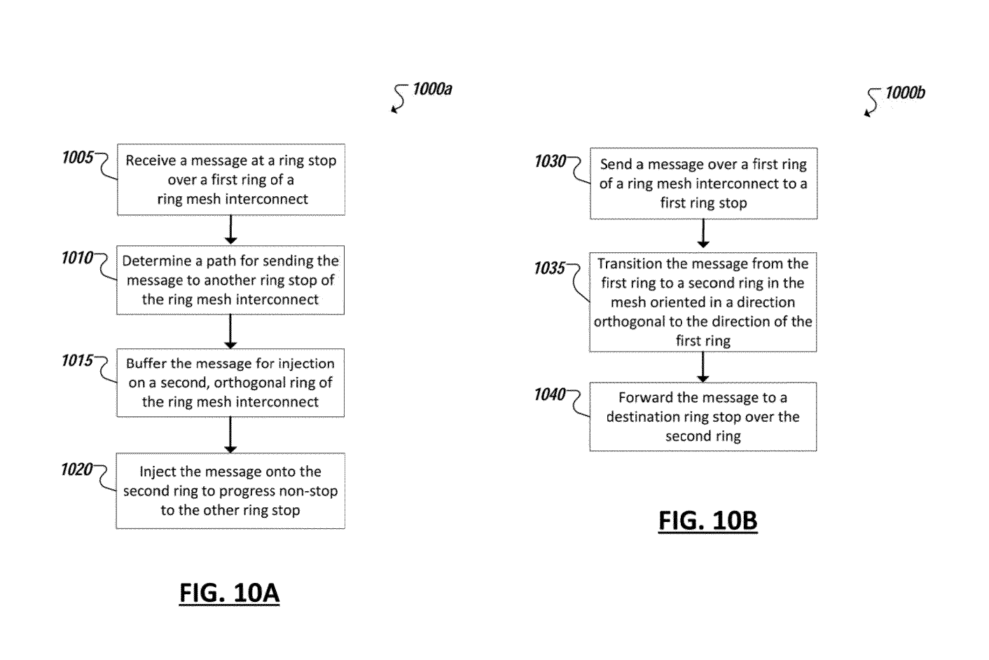

Turning now to the simplified flowcharts 1000a-b of FIGS. 10A-10B, example techniques are illustrated in connection with the transmission of transaction messages (or packets) on a ring mesh interconnect. In the example of FIG. 10A, a particular message can be received 1005 at a first ring stop connected to both a first ring of a ring mesh interconnect oriented in a first direction and a second ring in the mesh oriented in a second direction that is substantially orthogonal to the first direction. The message can be received, for instance, from another component and the message can be transmitted to the first ring stop along the first ring. In other instances, the message can be received from a core agent or cache agent corresponding to the first ring stop. The first ring stop can be the ring stop of a tile in a multi-core platform, the tile including both a CPU core (corresponding to the core agent) and a cache bank (e.g., of LLC) managed by the cache agent. The message can be destined for another component on a device including both the other component and the first ring stop. A path can be determined 1010 for the sending of the message to the ring stop of another component using the ring mesh interconnect and the message can be buffered 1015 for injection on the second ring of the ring mesh interconnect in accordance with the determined path. The particular message can be injected 1020 on the second ring, for instance, in response to identifying availability or bandwidth on the second ring. The particular message can be injected in accordance with flow control, message class, arbitration, and message starvation policies applicable to the ring mesh, among other examples. The injected message can then proceed non-stop to the other component over the second ring, regardless of whether the second ring passes over any other intervening rings oriented in the first direction.

Turning to the example of FIG. 10B, a message (such as one or more packets of a transaction) can be sent 1030 along a first ring interconnect of a ring mesh interconnect to a ring stop at a particular tile or component of a device. The ring mesh can include rings oriented in a first direction, such as the first ring, and rings oriented substantially orthogonal to the first direction in a second direction. The message can be ultimately destined for another component on the device and can be transitioned 1035 from the first ring to a second ring in the ring mesh interconnect oriented in the second direction. The message can then be forwarded 1040 along the second ring over one or more intervening rings positioned in the first direction to a ring stop of the destination component. The ability of messages to progress on a particular ring in the ring mesh non-stop over intervening (or intersecting) rings can be enabled by applying a ring interconnect protocol to the transmission of messages on the rings of the ring mesh interconnect.

Note that the apparatus', methods', and systems described above may be implemented in any electronic device or system as aforementioned. As specific illustrations, the examples below provide exemplary systems for utilizing the invention as described herein. As the systems below are described in more detail, a number of different interconnects are disclosed, described, and revisited from the discussion above. And as is readily apparent, the advances described above may be applied to any of those interconnects, fabrics, or architectures.

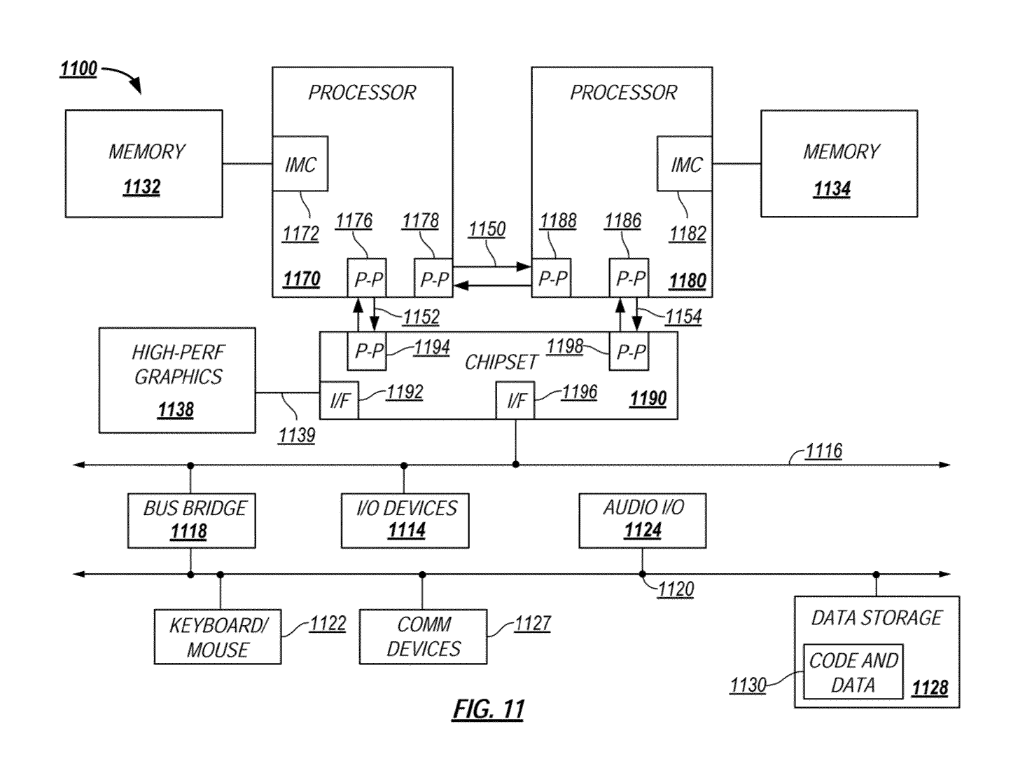

Referring now to FIG. 1, shown is a block diagram of a second system 1100 in accordance with an embodiment of the present invention. As shown in FIG. 11, multiprocessor system 1100 is a point-to-point interconnect system, and includes a first processor 1170 and a second processor 1180 coupled via a point-to-point interconnect 1150. Each of processors 1170 and 1180 may be some version of a processor. In one embodiment, 1152 and 1154 are part of a serial, point-to-point coherent interconnect fabric, such as Intel's Quick Path Interconnect (QPI) architecture. As a result, the invention may be implemented within the QPI architecture.

While shown with only two processors 1170, 1180, it is to be understood that the scope of the present invention is not so limited. In other embodiments, one or more additional processors may be present in a given processor.

Processors 1170 and 1180 are shown including integrated memory controller units 1172 and 1182, respectively. Processor 1170 also includes as part of its bus controller units point-to-point (P-P) interfaces 1176 and 1178; similarly, second processor 1180 includes P-P interfaces 1186 and 1188. Processors 1170, 1180 may exchange information via a point-to-point (P-P) interface 1150 using P-P interface circuits 1178, 1188. As shown in FIG. 11, IMCs 1172 and 1182 couple the processors to respective memories, namely a memory 1132 and a memory 1134, which may be portions of main memory locally attached to the respective processors.

Processors 1170, 1180 each exchange information with a chipset 1190 via individual P-P interfaces 1152, 1154 using point to point interface circuits 1176, 1194, 1186, 1198. Chipset 1190 also exchanges information with a high-performance graphics circuit 1138 via an interface circuit 1192 along a high-performance graphics interconnect 1139.

A shared cache (not shown) may be included in either processor or outside of both processors; yet connected with the processors via P-P interconnect, such that either or both processors' local cache information may be stored in the shared cache if a processor is placed into a low power mode.

Chipset 1190 may be coupled to a first bus 1116 via an interface 1196. In one embodiment, first bus 1116 may be a Peripheral Component Interconnect (PCI) bus, or a bus such as a PCI Express bus or another third generation I/O interconnect bus, although the scope of the present invention is not so limited.

As shown in FIG. 11, various I/O devices 1114 are coupled to first bus 1116, along with a bus bridge 1118 which couples first bus 1116 to a second bus 1120. In one embodiment, second bus 1120 includes a low pin count (LPC) bus. Various devices are coupled to second bus 1120 including, for example, a keyboard and/or mouse 1122, communication devices 1127 and a storage unit 1128 such as a disk drive or other mass storage device which often includes instructions/code and data 1130, in one embodiment. Further, an audio I/O 1124 is shown coupled to second bus 1120. Note that other architectures are possible, where the included components and interconnect architectures vary. For example, instead of the point-to-point architecture of FIG. 11, a system may implement a multi-drop bus or other such architecture.

While the present invention has been described with respect to a limited number of embodiments, those skilled in the art will appreciate numerous modifications and variations therefrom. It is intended that the appended claims cover all such modifications and variations as fall within the true spirit and scope of this present invention.

A design may go through various stages, from creation to simulation to fabrication. Data representing a design may represent the design in a number of manners. First, as is useful in simulations, the hardware may be represented using a hardware description language or another functional description language. Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, the data representing the hardware model may be the data specifying the presence or absence of various features on different mask layers for masks used to produce the integrated circuit. In any representation of the design, the data may be stored in any form of a machine readable medium. A memory or a magnetic or optical storage such as a disc may be the machine readable medium to store information transmitted via optical or electrical wave modulated or otherwise generated to transmit such information. When an electrical carrier wave indicating or carrying the code or design is transmitted, to the extent that copying, buffering, or re-transmission of the electrical signal is performed, a new copy is made. Thus, a communication provider or a network provider may store on a tangible, machine-readable medium, at least temporarily, an article, such as information encoded into a carrier wave, embodying techniques of embodiments of the present invention.

A module as used herein refers to any combination of hardware, software, and/or firmware. As an example, a module includes hardware, such as a micro-controller, associated with a non-transitory medium to store code adapted to be executed by the micro-controller. Therefore, reference to a module, in one embodiment, refers to the hardware, which is specifically configured to recognize and/or execute the code to be held on a non-transitory medium. Furthermore, in another embodiment, use of a module refers to the non-transitory medium including the code, which is specifically adapted to be executed by the microcontroller to perform predetermined operations. And as can be inferred, in yet another embodiment, the term module (in this example) may refer to the combination of the microcontroller and the non-transitory medium. Often module boundaries that are illustrated as separate commonly vary and potentially overlap. For example, a first and a second module may share hardware, software, firmware, or a combination thereof, while potentially retaining some independent hardware, software, or firmware. In one embodiment, use of the term logic includes hardware, such as transistors, registers, or other hardware, such as programmable logic devices.

Use of the phrase ‘to’ or ‘configured to,’ in one embodiment, refers to arranging, putting together, manufacturing, offering to sell, importing and/or designing an apparatus, hardware, logic, or element to perform a designated or determined task. In this example, an apparatus or element thereof that is not operating is still ‘configured to’ perform a designated task if it is designed, coupled, and/or interconnected to perform said designated task. As a purely illustrative example, a logic gate may provide a 0 or a 1 during operation. But a logic gate ‘configured to’ provide an enable signal to a clock does not include every potential logic gate that may provide a 1 or 0. Instead, the logic gate is one coupled in some manner that during operation the 1 or 0 output is to enable the clock. Note once again that use of the term ‘configured to’ does not require operation, but instead focus on the latent state of an apparatus, hardware, and/or element, where in the latent state the apparatus, hardware, and/or element is designed to perform a particular task when the apparatus, hardware, and/or element is operating.

Furthermore, use of the phrases ‘capable of/to,’ and or ‘operable to,’ in one embodiment, refers to some apparatus, logic, hardware, and/or element designed in such a way to enable use of the apparatus, logic, hardware, and/or element in a specified manner. Note as above that use of to, capable to, or operable to, in one embodiment, refers to the latent state of an apparatus, logic, hardware, and/or element, where the apparatus, logic, hardware, and/or element is not operating but is designed in such a manner to enable use of an apparatus in a specified manner.

A value, as used herein, includes any known representation of a number, a state, a logical state, or a binary logical state. Often, the use of logic levels, logic values, or logical values is also referred to as 1's and 0's, which simply represents binary logic states. For example, a 1 refers to a high logic level and 0 refers to a low logic level. In one embodiment, a storage cell, such as a transistor or flash cell, may be capable of holding a single logical value or multiple logical values. However, other representations of values in computer systems have been used. For example the decimal number ten may also be represented as a binary value of 1110 and a hexadecimal letter A. Therefore, a value includes any representation of information capable of being held in a computer system.

Moreover, states may be represented by values or portions of values. As an example, a first value, such as a logical one, may represent a default or initial state, while a second value, such as a logical zero, may represent a non-default state. In addition, the terms reset and set, in one embodiment, refer to a default and an updated value or state, respectively. For example, a default value potentially includes a high logical value, i.e. reset, while an updated value potentially includes a low logical value, i.e. set. Note that any combination of values may be utilized to represent any number of states.

The embodiments of methods, hardware, software, firmware or code set forth above may be implemented via instructions or code stored on a machine-accessible, machine readable, computer accessible, or computer readable medium which are executable by a processing element. A non-transitory machine-accessible/readable medium includes any mechanism that provides (i.e., stores and/or transmits) information in a form readable by a machine, such as a computer or electronic system. For example, a non-transitory machine-accessible medium includes random-access memory (RAM), such as static RAM (SRAM) or dynamic RAM (DRAM); ROM; magnetic or optical storage medium; flash memory devices; electrical storage devices; optical storage devices; acoustical storage devices; other form of storage devices for holding information received from transitory (propagated) signals (e.g., carrier waves, infrared signals, digital signals); etc, which are to be distinguished from the non-transitory mediums that may receive information there from.

Instructions used to program logic to perform embodiments of the invention may be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer).

The following examples pertain to embodiments in accordance with this Specification. One or more embodiments may provide an apparatus, a system, a machine readable storage, a machine readable medium, and a method to receive a particular message at a first ring stop connected to a first ring of a mesh interconnect comprising a plurality of rings oriented in a first direction and a plurality of rings oriented in a second direction substantially orthogonal to the first direction, and inject the particular message on a second ring of the mesh interconnect. The first ring can be oriented in the first direction, the second ring can be oriented in the second direction, and the particular message is to be forwarded on the second ring to another ring stop of a destination component connected to the second ring.

In at least one example, the particular message is to proceed non-stop to the destination component on the second ring. For instance, the other ring stop can be connected to the second ring and a third ring oriented in the first direction and the message can pass at least one other ring oriented in the first direction between the first ring and the third ring before arriving at the other ring stop.

In at least one example, messages to be injected on the second ring are arbitrated.

In at least one example, the messages are to be arbitrated according to a credited flow.

In at least one example, messages already on the second ring have priority over the particular message.

In at least one example, the message is received from another ring stop connected to the first ring and a third ring oriented in the second direction.

In at least one example, a path is determined for the message on the interconnect. The path can include a re-route of a previous path determined for the message. The path can utilize unidirectional transitions at ring stops from rings oriented in the first direction to rings oriented in the second direction.

In at least one example, second message is received on the second ring, and the second message is injected on the first ring for transmission to another ring stop connected to the first ring.

One or more embodiments may provide an apparatus, a system, a machine readable storage, a machine readable medium, and a method to provide a mesh interconnect to couple a plurality of central processing unit (CPU) cores and an on-die cache, where the mesh interconnect includes a first plurality of interconnects in a first orientation and a second plurality of interconnects in a second orientation orthogonal to the first orientation, each core is included on a respective tile and each tile is connected to one of the first plurality of interconnects and one of the second plurality of interconnects, and at least one ring interconnect protocol is to be applied to each of the interconnects in the first and second pluralities of interconnects.

In at least one example, the cache is partitioned into a plurality of cache banks and the tiles each include a respective one of the plurality of cache banks. Each tile can include a home agent and a cache agent. The home agent and cache agent can be a combined home-cache agent for the tile.

In at least one example, each tile includes exactly one ring stop connected to the respective one of the first plurality of interconnects and the respective one of the second plurality of interconnects connected to the tile. Each ring stop can include a transgress buffer to sink traffic from the respective one of the first plurality of interconnects and inject the traffic on the respective one of the second plurality of interconnects. Transgress buffers can be unidirectional or bidirectional.

In at least one example, the respective one of the first plurality of interconnects and the respective one of the second plurality of interconnects are each positioned over at least a portion of the corresponding tile.

In at least one example, each of the first plurality of interconnects and each of the second plurality of interconnects are at least one of a half-ring interconnect and a full-ring interconnect.

In at least one example, the at least one ring interconnect protocol are at least one of a flow control policy and message class policy adapted for ring interconnects.

In at least one example, the interconnect, the plurality of CPU cores and the on-die cache are included on one of a server system, personal computer, smart phone, tablet, or other computing device.

One or more embodiments may provide an apparatus, a system, a machine readable storage, a machine readable medium, and a method to send a message from a first ring stop of a first on-die component to a second ring stop of a second on-die component over a mesh interconnect, where the first ring stop is connected to a first interconnect in the mesh oriented in a first direction and a second interconnect in the mesh oriented in a second direction substantially orthogonal to the first direction, the second ring stop is connected to the first interconnect and a third interconnect in the mesh oriented in the second direction, and the message is to be sent using a ring interconnect protocol. The message can be transitioned from the first interconnect to the third interconnect at the second ring stop and the message can be forwarded on the third interconnect from the second ring stop to a third ring stop connected to the third interconnect.

In at least one example, a fourth interconnect oriented in the second direction is positioned between the second interconnect and the third interconnect, a fourth ring stop is connected to both the fourth interconnect and the first interconnect, and the message is to proceed non-stop to second ring stop on the first interconnect.

In at least one example, a path on the mesh interconnect can be determined and the message can be sent according to the path.

In at least one example, the mesh interconnect includes a first plurality of ring interconnects oriented in the first direction and a second plurality of ring interconnects oriented in the second direction, and the first interconnect is included in the first plurality of ring interconnects and the second and third interconnects are included in the second plurality of ring interconnects.

In at least one example, injection of messages on the third interconnect can be arbitrated such that messages already on the third interconnect have priority.

One or more embodiments may provide an apparatus, a system, a machine readable storage, a machine readable medium, and a method to provide a vertical ring stop for a vertical ring to couple a first plurality of tiles, each of the first plurality of tiles comprising a core and a cache, a horizontal ring stop for a horizontal ring to couple a second plurality of tiles, each of the second plurality of tiles comprising a core and a cache, and a transgress buffer included in a particular tile within the first plurality and second plurality of tiles, the transgress buffer to sink a packet to be received from the vertical ring stop and inject the packet on the horizontal ring through the horizontal ring stop.

In at least one example, non-pass through traffic from the vertical ring is to be injected directly to the horizontal ring.

In at least one example, traffic is capable of sinking from the horizontal ring for injection on the vertical ring when no other packets are switching from the horizontal ring to the vertical ring.

In at least one example, the vertical ring lack polarity rules.

In at least one example, the transgress buffer includes two or more read ports and two or more write ports and is operable to inject two or more packets per cycle.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the invention as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

1-34. (canceled)

35. An apparatus comprising:
I/O logic to:
receive a particular message at a first ring stop connected to a first ring of a mesh interconnect comprising a plurality of rings oriented in a first direction and a plurality of rings oriented in a second direction substantially orthogonal to the first direction; and
inject the particular message on a second ring of the mesh interconnect, wherein the first ring is oriented in the first direction, the second ring is oriented in the second direction, the particular message is to be forwarded to another ring stop of a destination component connected to the second ring, and the particular message is to proceed non-stop to the destination component on the second ring.

36. The apparatus of claim 35, wherein the other ring stop is connected to the second ring and a third ring oriented in the first direction and the message is to pass at least one other ring oriented in the first direction between the first ring and the third ring before arriving at the other ring stop.

37. The apparatus of claim 35, wherein the logic is further to arbitrate messages to be injected on the second ring.

38. The apparatus of claim 37, wherein the messages are to be arbitrated according to a credited flow.

39. The apparatus of claim 37, wherein messages already on the second ring have priority over the particular message.

40. The apparatus of claim 35, wherein the message is received from another ring stop connected to the first ring and a third ring oriented in the second direction.

41. The apparatus of claim 35, wherein the logic is further to determine a path for the message on the interconnect.

42. The apparatus of claim 41, wherein the path comprises a re-route of a previous path determined for the message.

43. The apparatus of claim 41, wherein the path is to utilize unidirectional transitions at ring stops from rings oriented in the first direction to rings oriented in the second direction.

44. The apparatus of claim 35, wherein the logic is further to:
receive a second message on the second ring; and
inject the second message on the first ring for transmission to another ring stop connected to the first ring.

45. A system comprising:
a mesh interconnect to couple a plurality of central processing unit (CPU) cores and an on-die cache, wherein the mesh interconnect includes a first plurality of interconnects in a first orientation and a second plurality of interconnects in a second orientation orthogonal to the first orientation, each core is included on a respective tile and each tile is connected to one of the first plurality of interconnects and one of the second plurality of interconnects, and at least one ring interconnect protocol is to be applied to each of the interconnects in the first and second pluralities of interconnects.

46. The system of claim 45, further comprising the plurality of cores and the on-die cache.

47. The system of claim 46, wherein the cache is partitioned into a plurality of cache banks and the tiles each include a respective one of the plurality of cache banks.

48. The system of claim 47, wherein each tile includes a home agent and a cache agent.

49. The system of claim 48, wherein the home agent and cache agent comprise a combined home-cache agent for the tile.

50. The system of claim 45, wherein each tile includes exactly one ring stop connected to the respective one of the first plurality of interconnects and the respective one of the second plurality of interconnects connected to the tile.

51. The system of claim 50, wherein each ring stop comprises a transgress buffer to sink traffic from the respective one of the first plurality of interconnects and inject the traffic on the respective one of the second plurality of interconnects.

52. The system of claim 51, wherein each transgress buffer comprises a unidirectional transgress buffer.

53. The system of claim 51, wherein each transgress buffer comprises a bidirectional transgress buffer.

54. The system of claim 45, wherein the respective one of the first plurality of interconnects and the respective one of the second plurality of interconnects are each positioned over at least a portion of the corresponding tile.

55. A method comprising:
sending a message from a first ring stop of a first on-die component to a second ring stop of a second on-die component over a mesh interconnect, wherein the first ring stop is connected to a first interconnect in the mesh oriented in a first direction and a second interconnect in the mesh oriented in a second direction substantially orthogonal to the first direction, the second ring stop is connected to the first interconnect and a third interconnect in the mesh oriented in the second direction, and the message is to be sent using a ring interconnect protocol;
transitioning the message from the first interconnect to the third interconnect at the second ring stop; and
forwarding the message on the third interconnect from the second ring stop to a third ring stop connected to the third interconnect.

56. The method of claim 55, wherein a fourth interconnect oriented in the second direction is positioned between the second interconnect and the third interconnect, a fourth ring stop is connected to both the fourth interconnect and the first interconnect, and the message is to proceed non-stop to second ring stop on the first interconnect.

57. The method of claim 56, further comprising determining a path on the mesh interconnect, wherein the message is sent according to the path.

58. The method of claim 55, wherein the mesh interconnect comprises a first plurality of ring interconnects oriented in the first direction and a second plurality of ring interconnects oriented in the second direction, and the first interconnect is included in the first plurality of ring interconnects and the second and third interconnects are included in the second plurality of ring interconnects.

59. The method of claim 55, further comprising arbitrating injection of messages on the third interconnect, wherein messages already on the third interconnect have priority.
